(19) United States
(12) Patent Application Publication
(10) Pub. No.: US 2025/0216557 A1
(43) Pub. Date: Jul. 3, 2025

(54) Object Detection Apparatus and Data Augmentation Method Thereof

(71) Applicants: Hyundai Motor Company, Seoul (KR); Kia Corporation, Seoul (KR)

(72) Inventors: Ju Heon Baeg, Seoul (KR); Yo Han Sung, Goyang-Si (KR)

(21) Appl. No.: 18/755,908

(22) Filed: Jun. 27, 2024

(30) Foreign Application Priority Data
Jan. 3, 2024 (KR) 10-2024-0001033

(51) Int. Cl. G01S 17/931; G01S 7/48; G01S 7/4865; G06T 7/11

(52) U.S. Cl. CPC G01S 17/931; G01S 7/4808; G01S 7/4865; G06T 7/11; G06T 2207/10028; G06T 2207/30252; G06T 2210/12

(57) ABSTRACT

An object detection apparatus for detecting a three-dimensional (3D) object using a light detection and ranging (LiDAR) point cloud and a data augmentation method thereof are provided. The object detection apparatus may obtain point cloud data that includes an object, perform data augmentation of the point cloud data by applying an augmentation technique that is determined based on a characteristic of the object, and control a vehicle based on the augmented point cloud data.

### CROSS-REFERENCE TO RELATED APPLICATION

This application claims the benefit of priority to Korean Patent Application No. 10-2024-0001033, filed in the Korean Intellectual Property Office on Jan. 3, 2024, the entire contents of which are incorporated herein by reference.

### TECHNICAL FIELD

The present disclosure relates to an object detection apparatus for detecting a three-dimensional (3D) object using a light detection and ranging (LiDAR) point cloud and a data augmentation method thereof.

### BACKGROUND

A 3D object detection device may simultaneously estimate bounding box information (e.g., a position (x, y, z), a size (width, length, height), and a heading angle) and a class of an object from a LiDAR point cloud by means of a deep learning-based detection network. The 3D object detection device may train the detection network to improve the performance of the detection network. A labeled bounding box and class ground-truth (GT) may be used to train the detection network. Furthermore, a data augmentation technology may be applied to improve the performance of training the detection network.

The data augmentation technology is a technique for applying various manipulation techniques to original data to increase the amount of data. Data augmentation may be further categorized as global augmentation and object augmentation. The global-augmentation technology may allow data to be processed for each object and/or each class by using an augmentation technique of rotating, reversing, or zooming in and/or out on a scene. The object-augmentation technology may allow data to be processed for each object or each class.

In some implementations, object-augmentation technology may cause probabilistic random augmentation for all objects without considering characteristics of objects. In other words, the object-augmentation technology in some implementations may randomly and probabilistically select which object to perform augmentation on and how much intensity to apply. Thus, data augmentation may be accompanied by a side effect in which data quality is not improved and/or deteriorates. For example, if a high degree of occlusion occurs for many areas of an object due to an obstacle or a preceding vehicle, data quality may deteriorate compared to the original after the original data of the object is augmented.

### SUMMARY

The present disclosure has been made to solve the above-mentioned problems occurring in some implementations while advantages achieved by those implementations are maintained intact.

An aspect of the present disclosure provides an object detection apparatus for augmenting data with regard to a characteristic of a single object and a data augmentation method thereof.

Another aspect of the present disclosure provides an object detection apparatus for adaptively adjusting an object area and application intensity based on a characteristic of a single object and performing efficient data augmentation to suit an object and dataset situation and a data augmentation method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an object detection apparatus may include: a processor configured to: obtain point cloud data including an object; and perform data augmentation of the point cloud data by applying an augmentation technique. The augmentation technique may be determined based on a characteristic of the object. The processor may be further configured to control a vehicle based on the augmented point cloud data.

The processor may be configured to perform the data augmentation by: segmenting the object into a plurality of partitions; determining a density of each of the plurality of segmented partitions; and determining, based on the determined density of each of the plurality of segmented partitions, a valid partition.

The processor may be configured to segment the object by: determining a quantity of partitions and a partition segmentation scheme based on a type of the object and the characteristic of the object.

The processor may be configured to determine the density by: determining the density using a quantity of a plurality of points of the object and a quantity of points which belong to each partition of the plurality of segmented partitions.

The processor may be configured to determine the valid partition by: comparing the determined density of a selected partition, of the plurality of segmented partitions, with a predetermined threshold; and determining, based on the determined density of the selected partition being greater than the predetermined threshold, the selected partition as the valid partition.

The processor may be configured to perform the data augmentation by: determining augmentation application intensity based on at least one of: a distance of the object, or a degree of occlusion of the object.

The processor may be configured to determine the augmentation application intensity by: determining a smallest distance of the object among distances between: an origin with respect to a vehicle coordinate system, and points in the object.

The augmentation technique may include at least one of a dropout technique, a sparse technique, or a noise technique.

The processor may be configured to perform the data augmentation by: determining a final augmentation technique to be applied to the data augmentation based on a selection probability for each predetermined augmentation technique.

The processor may be further configured to: train an object detection model using the augmented point cloud data.

According to one or more example embodiments of the present disclosure, a method may include: obtaining, by one or more processors, point cloud data including an object; and performing data augmentation of the point cloud data by applying an augmentation technique. The augmentation technique may be determined based on a characteristic of the object. The method may further include controlling a vehicle based on the augmented point cloud data.

Performing the data augmentation may include: segmenting the object into a plurality of partitions; determining a density of each of the plurality of segmented partitions; and determining, based on the determined density of each of the plurality of segmented partitions, a valid partition.

Segmenting the object may include: determining a quantity of partitions and a partition segmentation scheme based on a type of the object and the characteristic of the object.

Determining the density may include: determining the density using a quantity of a plurality of points of the object and a quantity of points which belong to each partition of the plurality of segmented partitions.

Determining the valid partition may include: comparing the determined density of a selected partition, of the plurality of segmented partitions, with a predetermined threshold; and determining, based on the determined density of the selected partition being greater than the predetermined threshold, the selected partition as the valid partition.

Performing the data augmentation may include: determining augmentation application intensity based on at least one of: a distance of the object, or a degree of occlusion of the object.

Determining the augmentation application intensity may include: determining a smallest distance of the object among distances between: an origin with respect to a vehicle coordinate system, and points in the object.

The augmentation technique may include at least one of a dropout technique, a sparse technique, or a noise technique.

Performing the data augmentation may include: determining a final augmentation technique to be applied to the data augmentation based on a selection probability for each predetermined augmentation technique.

The method may further include: training an object detection model using the augmented point cloud data.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an object detection apparatus according to embodiments of the present disclosure;

FIG. 2 is a flowchart illustrating a method for training an object detection network according to embodiments of the present disclosure;

FIG. 3 is a flowchart illustrating a data augmentation method according to embodiments of the present disclosure;

FIG. 4 is a flowchart illustrating a process of selecting a valid partition, which is shown in FIG. 3;

FIG. 5 is a drawing illustrating an example of segmenting an object partition according to embodiments of the present disclosure;

FIG. 6 is a flowchart illustrating a method for determining augmentation application intensity, which is shown in FIG. 3;

FIG. 7 is a graph illustrating an example of setting intensity for each distance section according to embodiments of the present disclosure;

FIG. 8 is a drawing for describing an object occlusion attribute according to embodiments of the present disclosure;

FIG. 9 is a drawing illustrating before and after data augmentation according to embodiments of the present disclosure; and

FIG. 10 is a block diagram illustrating a computing system for executing a data augmentation method according to embodiments of the present disclosure.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

A single-object-based attribute-aware data augmentation technology for efficiently augmenting data using a characteristic of a single object upon data augmentation for improving object detection training performance is proposed in the specification. Data augmentation may refer to application of one or more data manipulation techniques on an original data set (e.g., original data of a point cloud), such as dropout, swap, mix, sparse, and noise, to obtain a new data set having a different quantity of points (e.g., increased points or decreased points).

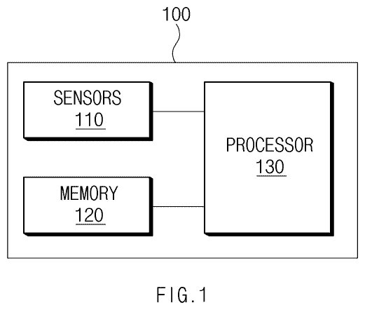

FIG. 1 is a block diagram illustrating a configuration of an object detection apparatus according to embodiments of the present disclosure.

An object detection apparatus 100 may be mounted on a vehicle to detect 3D information (or 3D object information) about an object (e.g., a pedestrian, a vehicle, a bus, a truck, and/or the like) around the vehicle. Referring to FIG. 1, the object detection apparatus 100 may include sensors 110, a memory 120, a processor 130, and the like.

The sensors 110 may obtain object information. The object information may be point cloud scene data (or point cloud data) having a labeled bounding box (or object) or the like. The sensors 110 may obtain a point cloud using a light detection and ranging (LiDAR) sensor or the like. The LiDAR sensor may radiate a laser pulse and may measure an arrival time of the laser pulse reflected from an object, thus calculating space position coordinates (or point information) at a reflection point.

The memory 120 may store a dataset which is training data. The training data may include ground truth (GT) data which is experimental information about an object. The memory 120 may store an object detection model (or an object detection network) which is a training target. The memory 120 may store a training model to which a deep learning network is applied. Furthermore, the memory 120 may store a data augmentation algorithm (or a data augmentation model).

The memory 120 may store the information (e.g., the point cloud data) obtained by the sensors 110. Furthermore, the memory 120 may store preset information and input data and/or output data of the processor 130.

The memory 120 may be a non-transitory storage medium which stores instructions executed by the processor 130. It is shown that the memory 120 is located outside the processor 130, but not limited thereto. The memory 120 may be located inside the processor 130. The memory 120 may include at least one of storage media such as a flash memory, a hard disk, a solid state disk (SSD), universal flash storage (UFS), a random access memory (RAM), a static RAM (SRAM), a read only memory (ROM), a programmable ROM (PROM), an electrically erasable and programmable ROM (EEPROM), or an erasable and programmable ROM (EPROM).

The processor 130 may include at least one of processing devices such as an application specific integrated circuit (ASIC), a digital signal processor (DSP), programmable logic devices (PLD), a field programmable gate array (FPGA), a central processing unit (CPU), a microcontroller, or a microprocessor.

The processor 130 may perform data augmentation depending on the data augmentation algorithm. The processor 130 may receive point cloud data as an input. The processor 130 may apply an augmentation technique with regard to a characteristic of a single object to perform the data augmentation. The augmentation technique may be a technique performed based on the single object. The processor 130 may output point cloud data augmented with regard to the characteristic of the single object. The processor 130 may train the object detection model by using the augmented data as training data. The augmented point cloud data may be used to control a vehicle (e.g., detect an object, steer or adjust speed to avoid the object, etc.).

Hereinafter, a description will be given of a process of performing single-object-based attribute-aware data augmentation with regard to the characteristic of the single object.

The processor 130 may receive point cloud data. The processor 130 may receive the point cloud data from the sensors 110. The processor 130 may access the point cloud data from the memory 120. The point cloud data may include at least one labeled object.

The processor 130 may perform partition segmentation for each object included in the point cloud data. The processor 130 may segment a bounding box (i.e., a labeled 3D box) of the object into a plurality of partitions, such as m partitions. The number (e.g., quantity) of partitions and the partition segmentation scheme may be determined based on a type of the object and/or a characteristic of the object.

The processor 130 may calculate density (or point density) for each partition of the object. The processor 130 may calculate a density dpi of an i-th partition using Equation 1 below.

$${d}_{pi} = \frac{{n}_{pi}}{{n}_{tot}} \qquad [ Equation 1 ]$$

Herein, nₚᵢ denotes the number of points which belong to the i-th partition and nₜₒₜ denotes the number of all the points of the object. The number of all the points of the object may be represented as Equation 2 below.

$${n}_{tot} = {\sum }_{i = 1}^{m} {n}_{pi} \qquad [ Equation 2 ]$$

Herein, m denotes the total number (e.g., quantity) of partitions.

The processor 130 may select a valid partition based on the calculated density for each partition of the object. The processor 130 may compare the density dₚᵢ of the i-th partition with a predetermined threshold dₜₕᵣ. If it is determined that the density dₚᵢ of the i-th partition is less than or equal to the predetermined threshold dₜₕᵣ, the processor 130 may exclude (e.g., except) the i-th partition from an augmentation application target. The processor 130 may determine that a partition with low density does not have sufficient point information to represent a characteristic of the object and may exclude the partition with the low density from the augmentation application target. The processor 130 may define a valid partition set P which remains after completing the task of excluding one or more partitions whose the density is less than or equal to the threshold, as Equation 3 below.

$$P = \{ {p}_{i} \vert {d}_{pi} > {d}_{thr} \} \qquad [ Equation 3 ]$$

In other words, if it is determined that the density dₚᵢ of the i-th partition is greater than the predetermined threshold dₜₕᵣ, the processor 130 may select the i-th partition as the augmentation application target, that is, the valid partition.

The processor 130 may determine augmentation application intensity x based on a distance of the object. The processor 130 may determine a value, having the shortest distance from the origin with respect to a vehicle coordinate system among points in the object, as a distance r of the object. The distance r of the object may be represented as Equation 4 below.

$$r = {min}_{j ∈ Q} ( \sqrt{{x}_{j}^{2} + {y}_{j}^{2}} ) \qquad [ Equation 4 ]$$

Herein, Q denotes a set of the points in the object, which may be defined as Q={xⱼ,yⱼ,zⱼ}ⱼ₌₁ⁿ^{ₜₒₜ}

Because there is a lack of feature information of an object far from the vehicle as there is a low number of points in original data of the object, deterioration in data quality may occur upon augmentation application at high intensity. The augmentation application intensity o may have a range from minimum 0 to maximum 1 and may be applied to be adaptable for each distance section. The augmentation application intensity according to the distance section may be predetermined by a designer or may be set as a relational expression in the form of a function.

Furthermore, the processor 130 may adjust the determined augmentation application intensity based on an occlusion degree of the object. If the occlusion degree of the object is high, because a point is lost as a specific area of the object is occluded, deterioration in data quality occurs upon augmentation application at high intensity. Any task may be performed at the augmentation application intensity x depending on the occlusion degree using an occlusion attribute which is present in the dataset, and augmentation may be applied to be adaptable. The designer may set the augmentation application intensity according to the occlusion degree of the object as the relational expression in the form of the function. Furthermore, the designer may segment the occlusion degree of the object into a plurality of sections and may set the augmentation application intensity to apply predetermined specific calculation for each section.

The processor 130 may adjust the augmentation application intensity according to the distance of the object based on the occlusion degree of the object. The processor 130 may adjust the determined augmentation application intensity a with regard to the occlusion degree OA of the object based on the distance of the object like Equation 5 below.

$$\hat{α} = \frac{α}{0 A + 1} \qquad [ Equation 5 ]$$

The processor 130 may apply a probability-based augmentation technique based on the selected valid partition and the adjusted augmentation application intensity. The probability-based augmentation technique may augment data based on the single object, which may include techniques such as a dropout technique, a sparse technique, and a noise technique. The dropout technique may reflect augmentation application intensity to eliminate a point of a current partition. The sparse technique may reflect augmentation application intensity to make a point density of a current partition sparse to be low. The noise technique may reflect augmentation application intensity to add any noise point to a current partition.

The processor 130 may finally select an augmentation technique to be applied for each partition which belongs to the valid partition set P based on a selection probability for each predetermined augmentation technique. The selection of the augmentation technique through the selection probability may follow a well-known usual method. For example, if selection probabilities of the dropout technique, the sparse technique, and the noise technique are preset to 0.1, 0.15, and 0.2, respectively, the processor 130 may apply the dropout technique to any one partition which belongs to the valid partition set P at the probability of 10%, may apply the sparse technique to the any one partition at the probability of 15%, and may apply the noise technique to the any one partition at the probability of 20%. At this time, several techniques may not be applied to one partition in duplicate. If there is a previously applied technique, a corresponding partition may be skipped. Augmentation application intensity when applying the augmentation technique may be obtained by obtaining previously adjusted augmentation application intensity.

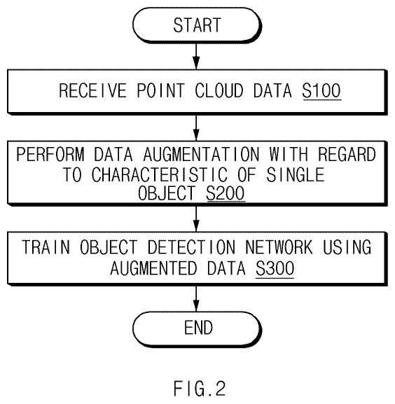

FIG. 2 is a flowchart illustrating a method for training an object detection network according to embodiments of the present disclosure.

Referring to FIG. 2, in S100, a processor 130 may receive point cloud data including label data. The processor 130 may receive the point cloud data from sensors 110 or may read (or access) the point cloud data from a memory 120.

In S200, the processor 130 may perform data augmentation with regard to a characteristic of a single object. The processor 130 may perform data augmentation for each object included in the point cloud data.

In S300, the processor 130 may train an object detection network using the augmented data. In other words, the processor 130 may train the object detection network by using the augmented data as training data. When completing the training of pieces of all point cloud data of a dataset, the processor 130 may end the training.

The above-mentioned embodiment is applied in only the training stage and is not applied in an inference stage on an application of the trained network model. Thus, the above-mentioned training method may improve the performance of detection accuracy without affecting a performance time upon actual inference.

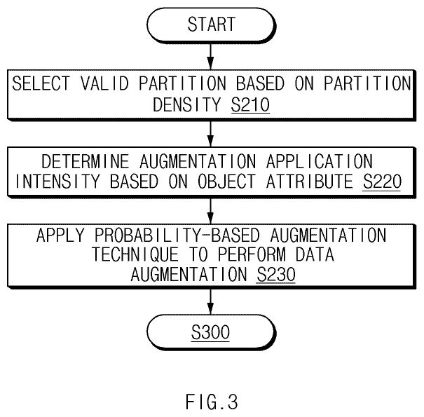

FIG. 3 is a flowchart illustrating a data augmentation method according to embodiments of the present disclosure.

In S210, a processor 130 may select a valid partition based on a partition density of an object. The processor 130 may segment a bounding box of the object into a plurality of partitions. The processor 130 may calculate density for each segmented partition and may select a valid partition based on the calculated density.

In S220, the processor 130 may determine augmentation application intensity based on object attribute. The processor 130 may adjust augmentation application intensity to be applied to the valid partition, based on the object attribute.

In S230, the processor 130 may apply a probability-based augmentation technique to perform the data augmentation. The processor 130 may apply the probability-based augmentation technique based on the valid partition selected in S210 and the augmentation application intensity determined in S220. The probability-based augmentation technique may augment data based on a single object. Techniques, such as a dropout technique, a sparse technique, and a noise technique, may be included in the probability-based augmentation technique. The dropout technique may reflect augmentation application intensity to eliminate a point of a current partition. The sparse technique may reflect augmentation application intensity to make a point density of a current partition sparse to be low. The noise technique may reflect augmentation application intensity to add any noise point to a current partition.

The processor 130 may finally select an augmentation technique to be applied for each partition which belongs to a valid partition set P based on a selection probability for each predetermined augmentation technique. The selection of the augmentation technique through the selection probability may follow a well-known usual method. For example, if selection probabilities of the dropout technique, the sparse technique, and the noise technique are preset to 0.1, 0.15, and 0.2, respectively, the processor 130 may apply the dropout technique to any one partition which belongs to the valid partition set P at the probability of 108, may apply the sparse technique to the any one partition at the probability of 15%, and may apply the noise technique to the any one partition at the probability of 20%. At this time, several techniques may not be applied to one partition in duplicate. If there is a previously applied technique, a corresponding partition may be skipped. Augmentation application intensity when applying the augmentation technique may be obtained by reflecting previously adjusted augmentation application intensity.

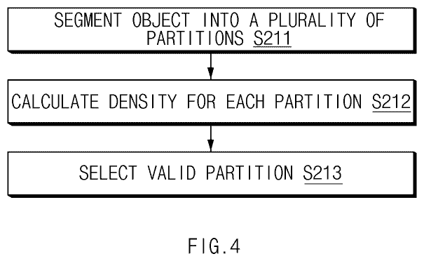

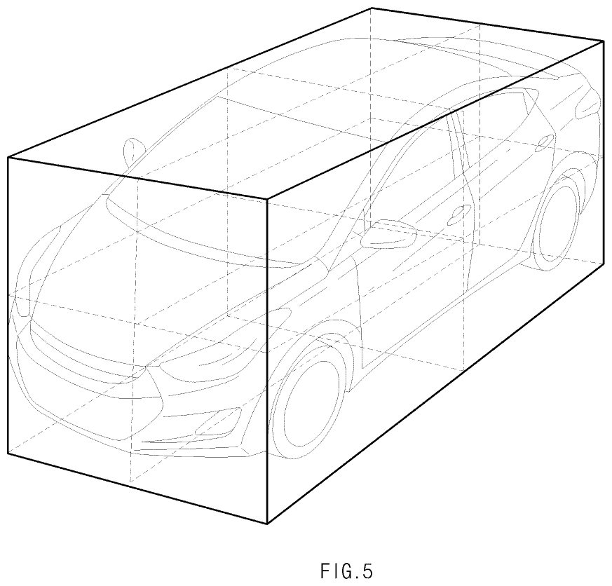

FIG. 4 is a flowchart illustrating a process of selecting a valid partition, which is shown in FIG. 3. FIG. 5 is a drawing illustrating an example of segmenting an object partition according to embodiments of the present disclosure.

In S211, a processor 130 may segment an object into a plurality of partitions. The processor 130 may segment a bounding box (i.e., a labeled 3D box) of the object into m partitions. For example, as shown in FIG. 5, the processor 130 may segment a bounding box of a vehicle object into 8 partitions. The number of partitions and the partition segmentation scheme may be determined based on a type of the object and a characteristic of the object.

In S212, the processor 130 may calculate density for each partition of the object. The processor 130 may calculate a density dₚᵢ of an i-th partition using Equation 1 above.

In S213, the processor 130 may select a valid partition based on the calculated density for each partition of the object. The processor 130 may determine the density dₚᵢ of the i-th partition is less than or equal to a predetermined threshold dₜₕᵣ. If it is determined that the density dₚᵢ of the i-th partition is less than or equal to the predetermined threshold dₜₕᵣ, the processor 130 may except the i-th partition from an augmentation application target. The processor 130 may determine that a partition with low density does not have sufficient point information to represent a characteristic of the object and may except the partition with the low density from the augmentation application target. The processor 130 may define a valid partition set P including a partition which remains after completing the task of excepting the partition, the density of which is less than or equal to the threshold.

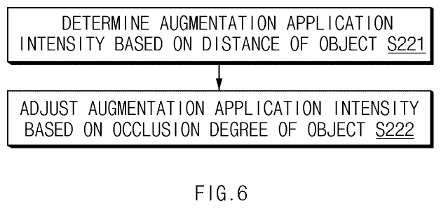

FIG. 6 is a flowchart illustrating a method for determining augmentation application intensity, which is shown in FIG. 3.

In S221, a processor 130 may determine augmentation application intensity a based on a distance of an object. The processor 130 may determine a value, having the shortest distance from the origin with respect to a vehicle coordinate system among points in the object, as a distance r of the object. Because there is a lack of feature information of an object far from a vehicle as there is a low number of feature points in original data of the object, deterioration in data quality may occur upon augmentation application at high intensity. The augmentation application intensity x may have a range from minimum 0 to maximum 1 and may be applied to be adaptable for each distance section. The augmentation application intensity according to the distance section may be predetermined by a designer or may be set as a relational expression in the form of a function.

In S222, the processor 130 may adjust the determined augmentation application intensity x based on an occlusion degree of the object. The processor 130 may adjust the determined augmentation application intensity o based on the distance of the object with regard to an occlusion degree OA of the object. If the occlusion degree of the object is high, because a point is lost as a specific area of the object is occluded, deterioration in data quality occurs upon augmentation application at high intensity. Any task may be performed at the augmentation application intensity x depending on the occlusion degree using an occlusion attribute which is present in a dataset, and augmentation may be applied to be adaptable. The designer may set the augmentation application intensity according to the occlusion degree of the object as the relational expression in the form of the function. Furthermore, the designer may segment the occlusion degree of the object into a plurality of sections and may set the augmentation application intensity to apply predetermined specific calculation for each section.

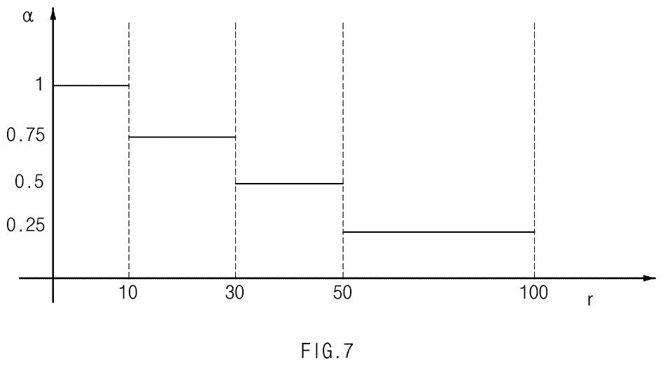

FIG. 7 is a graph illustrating an example of setting intensity for each distance section according to embodiments of the present disclosure.

Referring to FIG. 7, a processor 130 may determine augmentation application intensity as 1, if the distance of an object is greater than 0 m and is less than or equal to 10 m, and may determine the augmentation application intensity as 0.75, if the distance of the object is greater than 10 m and is less than or equal to 30 m. Furthermore, the processor 130 may determine the augmentation application intensity as 0.5, if the distance of the object is greater than 30 m and is less than or equal to 50 m, and may determine the augmentation application intensity as 0.25, if the distance of the object is greater than 50 m and is less than or equal to 100 m. If the distance of the object is greater than 100 m, the processor 130 may determine the augmentation application intensity as 0.

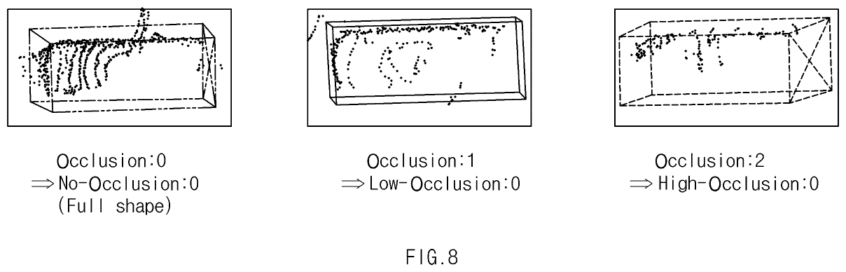

FIG. 8 is a drawing for describing an object occlusion attribute according to embodiments of the present disclosure.

Referring to FIG. 8, an occlusion attribute (OA) included in a dataset may be assigned in the form of a flag such as 0, 1, and 2 There is no occlusion of an object, the OA of the object, 0, may be assigned. If the OA of the object is less than or equal to a threshold, the OA of the object, 1, may be assigned. Furthermore, if the OA of the object is greater than the threshold, the OA of the object, 2, may be assigned.

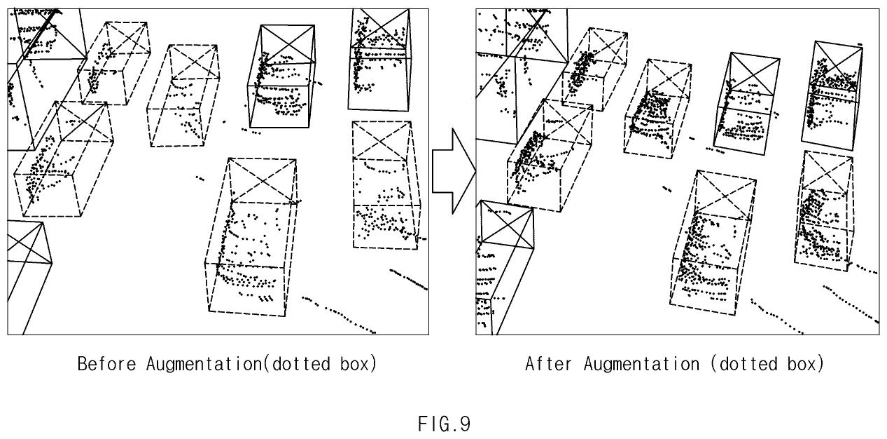

FIG. 9 is a drawing illustrating before and after data augmentation according to embodiments of the present disclosure.

Referring to FIG. 9, it may be identified that data quality is improved, if a data augmentation method according to embodiments disclosed in the specification is applied.

Furthermore, referring to Table 1 in which the result of being evaluated using an evaluation method used in the field of object detection, mean average precision (mAP), is disclosed, the improvement width of training performance (i.e., the performance of object detection in an object detection network) is small and performance actually deteriorates, if applying an existing object augmentation technology to a baseline to train the object detection network, compared to if training the object detection network using the baseline.

It may be identified that the improvement width of training performance increases and performance degraded if applying the existing object augmentation technology to train the object detection network is improved, if applying an augmentation technology considering an object characteristic according to embodiments disclosed in the specification to the baseline to train the object detection network, compared to if training the object detection network using the baseline.

TABLE 1

| | | | Apply object |
|---|---|---|---|
| | | Apply existing object | characteristic-based |
| | | augmentation to | augmentation to |
| mAP /method | Baseline | baseline | baseline |
| car/easy | 78.22 | 77.97 (−0.26) | 80.22 (+2.0) |
| car/moderate | 71.13 | 71.52 (+0.39) | 71.57 (+0.45) |
| car/hard | 49.66 | 49.76 (+0.1) | 49.88 (+0.21) |
| van/easy | 74.37 | 75.06 (+0.69) | 77.73 (+3.36) |
| van/moderate | 65.47 | 64.86 (−0.60) | 66.75 (+1.28) |
| van/hard | 43.08 | 43.60 (+0.52) | 43.68 (+0.59) |

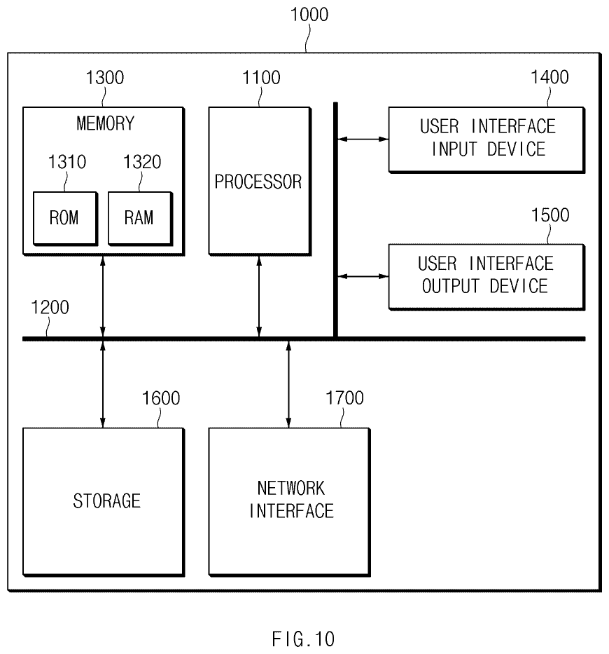

FIG. 10 is a block diagram illustrating a computing system for executing a data augmentation method according to embodiments of the present disclosure. Referring to FIG. 10, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM. The exemplary storage medium may be coupled to the processor 1100. The processor 1100 may read out information from the storage medium and may write information in the storage medium. Alternatively, the storage medium may be integrated with the processor 1100. The processor 110 and the storage medium may reside in an application specific integrated circuit (ASIC). The ASIC may reside within a user terminal. In another case, the processor 1100 and the storage medium may reside in the user terminal as separate components.

Embodiments of the present disclosure may improve training performance through efficient data augmentation even for a dataset with high difficulty.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed following claims. Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An object detection apparatus comprising:
a processor configured to:
obtain point cloud data comprising an object;
perform data augmentation of the point cloud data by applying an augmentation technique, wherein the augmentation technique is determined based on a characteristic of the object; and
control a vehicle based on the augmented point cloud data.

2. The object detection apparatus of claim 1, wherein the processor is configured to perform the data augmentation by:
segmenting the object into a plurality of partitions;
determining a density of each of the plurality of segmented partitions; and
determining, based on the determined density of each of the plurality of segmented partitions, a valid partition.

3. The object detection apparatus of claim 2, wherein the processor is configured to segment the object by:
determining a quantity of partitions and a partition segmentation scheme based on a type of the object and the characteristic of the object.

4. The object detection apparatus of claim 2, wherein the processor is configured to determine the density by:
determining the density using a quantity of a plurality of points of the object and a quantity of points which belong to each partition of the plurality of segmented partitions.

5. The object detection apparatus of claim 2, wherein the processor is configured to determine the valid partition by:
comparing the determined density of a selected partition, of the plurality of segmented partitions, with a predetermined threshold; and
determining, based on the determined density of the selected partition being greater than the predetermined threshold, the selected partition as the valid partition.

6. The object detection apparatus of claim 1, wherein the processor is configured to perform the data augmentation by:
determining augmentation application intensity based on at least one of:
a distance of the object, or
a degree of occlusion of the object.

7. The object detection apparatus of claim 6, wherein the processor is configured to determine the augmentation application intensity by:
determining a smallest distance of the object among distances between:
an origin with respect to a vehicle coordinate system, and
points in the object.

8. The object detection apparatus of claim 1, wherein the augmentation technique comprises at least one of a dropout technique, a sparse technique, or a noise technique.

9. The object detection apparatus of claim 1, wherein the processor is configured to perform the data augmentation by:
determining a final augmentation technique to be applied to the data augmentation based on a selection probability for each predetermined augmentation technique.

10. The object detection apparatus of claim 1, wherein the processor is further configured to:
train an object detection model using the augmented point cloud data.

11. A method comprising:
obtaining, by one or more processors, point cloud data comprising an object;
performing data augmentation of the point cloud data by applying an augmentation technique, wherein the augmentation technique is determined based on a characteristic of the object; and
controlling a vehicle based on the augmented point cloud data.

12. The method of claim 11, wherein the performing of the data augmentation comprises:
segmenting the object into a plurality of partitions;
determining a density of each of the plurality of segmented partitions; and
determining, based on the determined density of each of the plurality of segmented partitions, a valid partition.

13. The method of claim 12, wherein the segmenting of the object comprises:
determining a quantity of partitions and a partition segmentation scheme based on a type of the object and the characteristic of the object.

14. The method of claim 12, wherein the determining of the density comprises:
determining the density using a quantity of a plurality of points of the object and a quantity of points which belong to each partition of the plurality of segmented partitions.

15. The method of claim 12, wherein the determining of the valid partition comprises:
comparing the determined density of a selected partition, of the plurality of segmented partitions, with a predetermined threshold; and
determining, based on the determined density of the selected partition being greater than the predetermined threshold, the selected partition as the valid partition.

16. The method of claim 11, wherein the performing of the data augmentation comprises:
determining augmentation application intensity based on at least one of:
a distance of the object, or
a degree of occlusion of the object.

17. The method of claim 16, wherein the determining of the augmentation application intensity comprises:
determining a smallest distance of the object among distances between:
an origin with respect to a vehicle coordinate system, and
points in the object.

18. The method of claim 11, wherein the augmentation technique comprises at least one of a dropout technique, a sparse technique, or a noise technique.

19. The method of claim 11, wherein the performing of the data augmentation comprises:
determining a final augmentation technique to be applied to the data augmentation based on a selection probability for each predetermined augmentation technique.

20. The method of claim 11, further comprising:
training an object detection model using the augmented point cloud data.
